(19) United States
(12) Patent Application Publication
(10) Pub. No.: US 2003/0225604 A1
(43) Pub. Date: Dec. 4, 2003

(54) System and method for analyzing data and making predictions

(76) Inventors: Fabio Casati, Palo Alto, CA (US); Ming-Chien Shan, Saratoga, CA (US); Umeshwar Dayal, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/164,175

(22) Filed: Jun. 4, 2002

(51) Int. Cl. G06F 17/60; G06F 17/30

(52) U.S. Cl. 705/7; 707/7

(57) ABSTRACT

A computer-based system comprises a warehouse configured to store a plurality of types of data, a prediction model, and a process definition, a script configured to selectively extract business process execution data from the log and store the extracted business process execution data in the warehouse, a business process intelligence engine configured to execute an algorithm responsive to at least some of the data stored in the warehouse and to store result data in the warehouse, and a monitoring and optimization manager configured to predict an occurrence of an exception in a business process execution responsive to at least some of each of the data stored in the warehouse, the business process execution data, and the process definition.

### FIELD OF THE INVENTION

The invention relates to automated business decision making and prediction of the outcome and quality of the business processes executed by an organization.

### BACKGROUND OF THE INVENTION

Companies deploy and integrate different kinds of software systems and applications to automate and manage the execution of mission-critical business processes, within and across organizations, to increase revenue and reduce costs. The resulting software architectures are typically complex, and include a variety of technologies and tools. The collection the tools deployed by an organization to execute business processes and deliver services to customers and employees is called E-Business System (E-BUSINESS SYSTEM). Such business process automation technologies are being increasingly directed toward improving the quality and efficiency of both internal processes and the e-services (i.e., Internet-based services) offered to customers.

In particular, it is crucial for organizations to meet the Service Level Agreements (SLAs) stipulated with their customers and to foresee as early as possible the risk of failing to meet Service Level Agreement criteria (often through missed deadlines), in order to establish appropriate expectations and to allow for effective corrective action.

In order to attract and retain customers as well as business partners, organizations need to provide their services (i.e., execute their processes) with a high, consistent, and predictable quality. From a process automation perspective, this has several implications: for example, the business processes should be correctly designed; their execution should be supported by a system that can meet the workload requirements; and the process resources (human or automated) should be able to perform their assigned tasks in a timely fashion.

While numerous E-business systems are in use and others have been proposed, few, if any, are known which are designed to identify and predict the outcome and quality of the business process execution, as well as the occurrence of exceptions. The term “exception” has been used with several different meanings in the process automation communities; as used herein an exception is defined as a deviation from the “optimal” (or acceptable) process execution that prevents the delivery of services with the desired (or agreed) quality. This is a high-level, user-oriented notion of the concept, where it is up to the process designers and administrators to define what they consider to be an exception, therein characterizing a problem they would like to address and avoid. In particular, an exception is defined by a condition on the execution data, stored in the warehouse. The condition can be specified in a programming languages, such as Java or SQL.

Delays in completing an order fulfillment process or the escalation of complaints to a manager in a customer care process are typical examples of exceptions. In the first case, a company is not able to meet the Service Level Agreements while in the second case the service is delivered with acceptable quality from the customer's point-of-view, but with higher operating costs and therefore with unacceptable quality from the service provider's perspective.

Therefore, it is desirable to provide an automated system capable of analyzing, predicting, and assisting in the prevention of exceptions in the business process execution.

### SUMMARY OF THE INVENTION

The invention relates to E-business systems. More particularly, the invention relates to automated systems and methods of analyzing data related to instances of predefined processes and predicting the outcome, quality, and the occurrence of an exception within a business process execution.

One aspect of the invention provides a method of analyzing data and making predictions, comprising reading process execution data from logs, collecting the execution data and storing the execution data in a memory defining a warehouse, analyzing the data, and generating prediction models in response to analyzing the data.

Another aspect of the invention provides a computer-based system comprising a memory defining execution logs configured to store business process execution data, a memory defining a warehouse configured to store a plurality of types of data, a prediction model, and a process definition, a memory bearing computer software code that, when loaded in a general purpose computer, selectively extracts business process execution data from the log and stores the extracted business process execution data in the warehouse, a memory bearing computer software code that, when loaded in a general purpose computer, defines a business process intelligence engine configured to execute an algorithm responsive to at least some of the types of data stored in the warehouse and to store result data in the warehouse, and a memory bearing computer software code that, when loaded in a general purpose computer, defines a monitoring and optimization manager configured to predict an occurrence of an exception in a business process execution responsive to at least some of each of the data stored in the warehouse, the business process execution data, and the process definition.

Another aspect of the invention provides a method comprising storing a plurality of business process execution data in a database, selectively extracting at least some business process execution data from the database, applying a first algorithm to the extracted data and storing at least one data table in the database responsive to the first algorithm, and applying a second algorithm to the at least one data table and selectively predicting an exception to a business process execution responsive to the second algorithm.

### DESCRIPTION OF THE DRAWINGS

FIG. 1 is a block diagram of an example e-business system.

FIG. 2 is a flowchart of an embodiment of the invention.

FIG. 3 is a flowchart of a sub-process included in the process of FIG. 1.

FIG. 4 is a flowchart of another sub-process included in the process of FIG. 1.

FIG. 5 is a flowchart of yet another sub-process included in the process of FIG. 1.

FIG. 6 is a flowchart of still another sub-process included in the process of FIG. 1.

FIG. 7 is a block diagram illustrating an interrelationship of elements of an E-business analysis system according to one embodiment of the invention.

FIG. 8 is a block diagram of networked resources in accordance with one embodiment of the invention.

FIG. 9 is a block diagram of flowchart of another embodiment of the invention, having an iterative execution aspect.

### DETAILED DESCRIPTION OF THE INVENTION

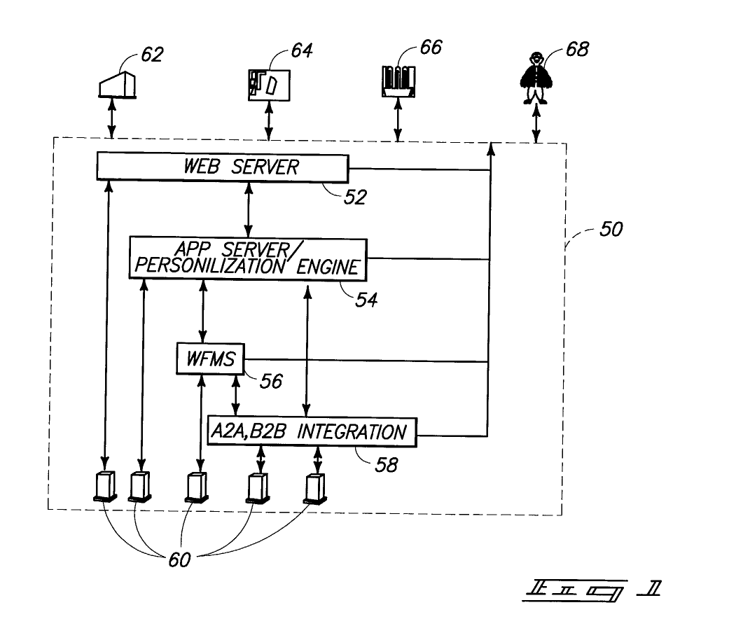

FIG. 1 illustrates an example E-business system 50. The E-business system 50 includes a web server 52. The web server 52 accepts and serves static HTTP requests, as well as handling dynamic HTTP requests. The E-business system 50 also includes application server/personalization engine 54, which processes non-static HTTP requests. The E-business system 50 also includes a workflow management system 56. The workflow management system 56 automates the execution of business processes and allows simple forms of business process monitoring and analysis. Further included in the E-business system 50 is an A2A and B2B integration platform 58. The A2A and B2B integration platform 58 is used to integrate software business tools available from various vendors. In general, E-business systems may include some of the above components, all of them, or even additional components.

The E-business system 50 includes a number of applications 60, represented by a respective number of host platforms. These applications 60 may include various software business tools from a variety of different vendors; for example, database management systems, data mining tools, etc. Specific examples are provided hereafter. Further illustrated in FIG. 1 are entities 62, 64, 66 and 68, which interact with E-business system 50 from an external position. The entities 62, 64, 66 and 68 may include, for example, managers and personnel from within the system 50 host corporation, business partners, vendors or other external service providers, and clientele.

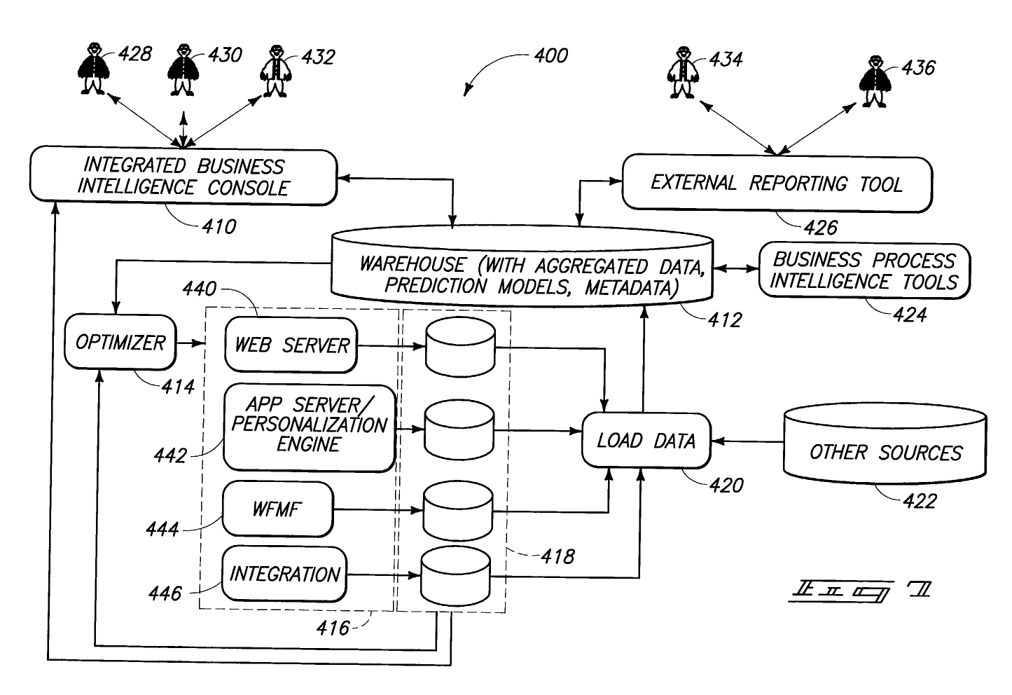

FIG. 7 illustrates a system 400 in accordance with one embodiment of the invention. The system 400 includes an integrated business intelligence console 410; a data warehouse 412; an optimizer 414; an E-business system 416; execution logs 418; a load data block 420; other sources 422; business process intelligence tools 424; and external reporting tools 426. Further shown are human resources 428, 430, 432, 434, and 436. The role and constituency of each element of embodiment 400 shall be described as follows.

The integrated business intelligence console 410 is a graphical user interface that allows users (i.e., human resources) 428, 430, and 432 to browse the content of the process data warehouse 412 and to retrieve the results of analysis (subsequently described).

The data warehouse 412 stores business process execution data, logged by the different components of the E-business system 416, and possibly other data such as, for example, user-defined classification of the processes.

The optimizer 414 gathers data from the warehouse 412 and utilizes it to optimize presently-running business process execution executions. For example, if a business process execution is predicted to be “late”, then the optimizer 414 raises the priority of the remaining steps (i.e., nodes) within the business process execution to expedite execution in an attempt to avoid missing a deadline.

The E-business system 416, also referred to as the process engine, is the component that executes business processes. The E-business system 416 includes a web server 440, which accepts and serves static HTTP requests, as well as handling dynamic HTTP requests. The E-business system 416 also includes an application server/personalization engine 442, which processes non-static HTTP requests. The application server/personalization engine 442 may offer implementations of the Java J2EE specifications, and may also provide features to support the reliable, personalized multi-device delivery of business services. Also, the application server/personalization engine 442 may provide XML document management capabilities.

The E-business system 416 also includes a workflow management system 444. The workflow management system 444 automates the execution of business processes within and across organizations, as well as allowing simple forms of business process monitoring and analysis. The E-business system 416 further includes an integration platform 446. The integration platform 446 operates to hide the heterogeneity of any back-end application or applications which may be present, and provides a homogeneous model and protocol to access heterogeneous applications. For example, the integration platform 446 may be used to integrate both internal (i.e., A2A) and external (i.e., B2B) business tools that are currently available from various vendors.

The execution log 418 is a database that contains business process execution data, and is written by the different components of the E-business system 416. As illustrated, the execution log 418 comprises a number of discrete data storage elements (i.e., databases, disk drives, etc.) which are individually accessible by elements 410, 414, 420 (subsequently described), 440, 442, 444 and 446.

The load data block 420 is a component that retrieves data from the execution logs 418 and stores it into the warehouse 412. In addition, the load data block 420 checks that data for consistency and converts the data format to one which is compatible with the warehouse 412.The load data block also perform data correlation, that is, it takes the log entries independently written by the different components of the E-business system and tags them with the identifier of the business process execution to which they belong, so that the analysis system can use this information to analyze the end-to-end execution of each individual business process execution.

The other sources 422 are any other information provided by a user 428, 430, 432, 434, and 436; for example, taxonomy used to classify processes.

The business process intelligence tools 424 are data mining applications and techniques used to perform data analysis. For example, tools 424 can perform “classification”—that is, derive rules according to which specific processes belong to specific classes. As a further example, tools 424 can “discover” that processes started by a particular user (i.e., John Doe) are statistically “slow”, when compared to other similar processes started by other users.

The external reporting tools 426 can be, for example, commercially available software tools that execute queries over a database and provide results in graphical form. Examples of such tools 426 are Crystal Reports, available from Crystal Decisions (formerly Seagate Software), Vancouver BC (www.crystaldecisions.com), or Oracle Discoverer, available from Oracle Corporation, Redwood Shores, Calif. (www.oracle.com). The tools 426 are selectively accessed by users 434 and 436, as shown.

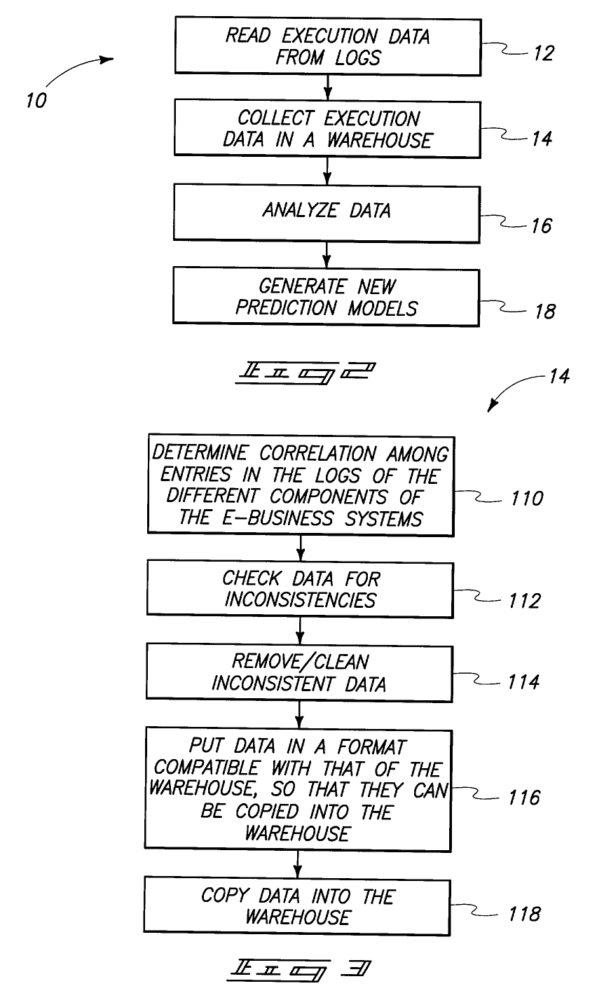

FIG. 2 illustrates a data analysis and prediction process embodying various aspects of the invention and designated by numeral 10.

The process 10 includes process blocks read execution data from logs 12; collect execution data in a warehouse 14; analyze data 16; and generate new prediction models 18. Each of the process blocks 12, 14, 16 and 18 comprise sub-process steps described hereafter.

The read execution data block 12 (see FIGS. 2 and 7) is executed as follows. As business process executions are carried out, data is recorded in the execution logs 418. Business process executions carried out can be, for example, ordering of materials, approval of an expense request, performing a warehouse inventory, transmitting deliverables to a client, etc. Audit data related to business process executions includes, for example, the names of the persons involved in the business process execution, the time spent at each step of the business process execution, material resources used and consumed during the business process execution, physical locations where business process execution steps were completed, etc. Then, a load data block 420 is executed to extract pertinent business process execution data from the workflow audit logs 418 and to pass that data on to steps subsequently described.

FIG. 3 illustrates the steps of the collect execution data block 14. In step 110, the correlations among business process execution data extracted by algorithms in load data block 420, to label log entries with the business process execution to which they are related.

In step 112, the data is then checked for inconsistencies (i.e., conflicting names or time stamps attributed to a business process execution, etc.

In step 114, inconsistent data (which is often present in the execution log written by the components of the E-business system) is removed or otherwise cleaned from the business process execution data. Cleaning the data may include, for example, selecting only verified data or eliminating data bearing clearly erroneous time-stamps.

In step 116, the cleaned business process execution data is now formatted for storage in a data warehouse 412.

Then, in step 118, the formatted data is copied into warehouse 412.

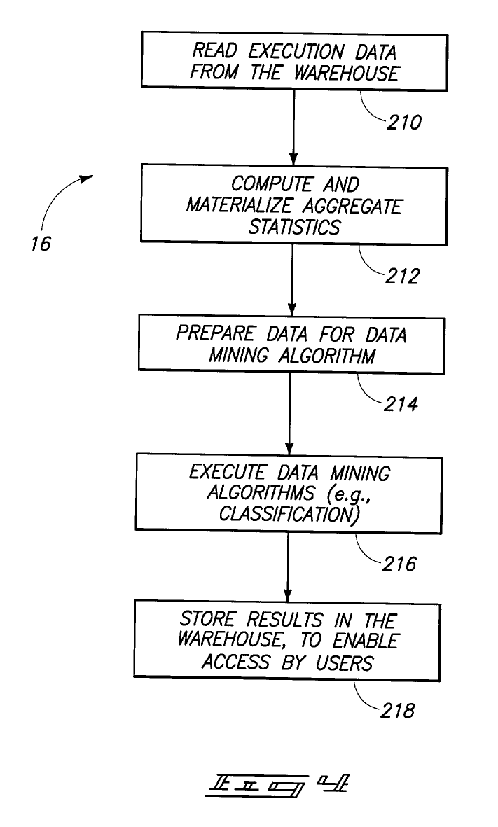

FIG. 4 shows details of the analyze data block 16, which follows collect execution data block 14, in accordance with one embodiment. In step 210, the business process execution data which was transferred to the warehouse 412 in step 118 is read from the warehouse 412. This read data, which has been cleaned and formatted in previous steps 114 and 116, respectively, is referred to hereafter as execution data.

In step 212, statistical calculation techniques are applied to the execution data to compute and compile aggregate statistics (such as the average) of the execution data. Such statistics may be recalled subsequently by a user during another analysis or audit, or put to other use. Statistics may be computed based on user-defined logic, expressed for example in SQL.

In step 214, the execution data is prepared for the subsequent application of data mining.

In step 216, one or more data mining processes are executed in step 216, which classify or otherwise segregate the execution data into a plurality of tables. One data mining technique that could be used is described in greater detail in U.S. patent application Ser. No. 09/464,311, filed Dec. 15, 1999, titled “Custom Profiling Apparatus for Conducting Customer Behavior Pattern Analysis, and Method for Comparing Customer Behavior Patterns”, naming Qiming Chen, Umeshwar Dayal, and Meichun Hsu as inventors, and which is incorporated herein by reference. Other data mining techniques are possible. Attention is also direct to U.S. patent application Ser. No. 09/860,230, filed May 18, 2001, titled “Method of Identifying and Analyzing Business Processes from Workflow Audit Logs”, listing as inventors Fabio Casati, Ming-Chien Shan, Li-Jie Jin, Umeshwar Dayal, Daniela Grigori, and Angela Bonifati, Attorney Docket Number 10010068-1, which is incorporated herein by reference.

In step 218, the resulting tables are stored in warehouse 412, in a format accessible by system users.

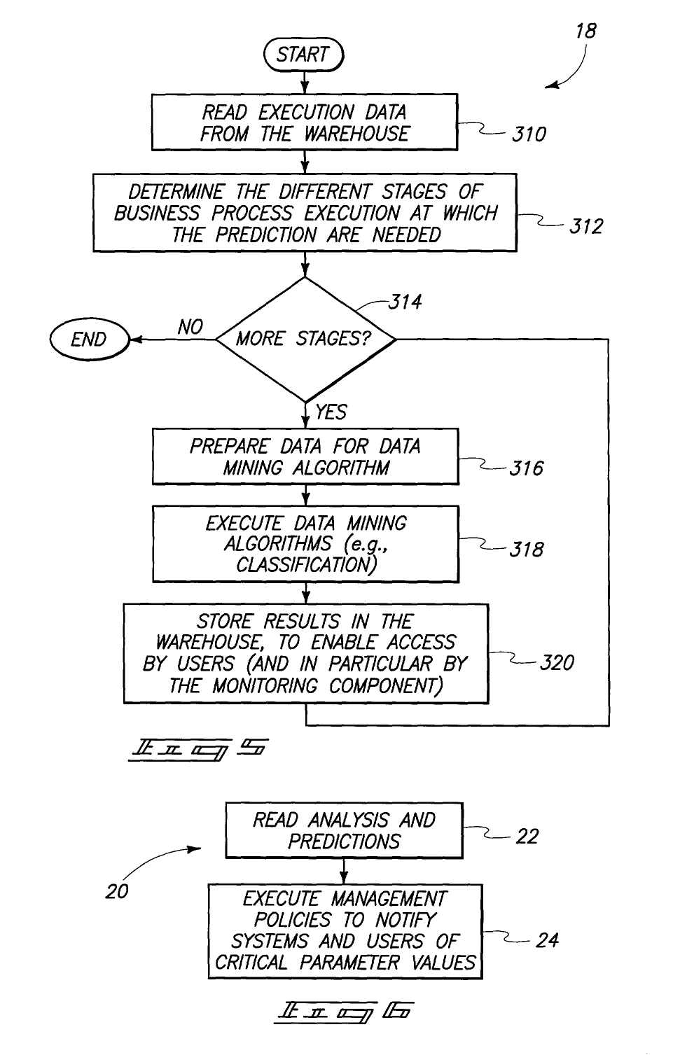

FIG. 5 shows details of the generate new prediction models block 18, in accordance with one embodiment. In step 310, instance data is read from the warehouse 412.

In step 312, business process intelligence processes are applied to the business process execution data read in step 310, to determine which different stages (i.e., steps) of a pre-defined process require the prediction the outcome, quality, or of the occurrence of exceptions in given (i.e., present or future) business process execution. As used herein, an exception is defined as a deviation from the “optimal” (or acceptable) process execution that prevents the delivery of services with the desired (or agreed) quality. This is a high-level, user-oriented notion of the concept, where it is up to the process designers and administrators to define what they consider to be an exception, therein characterizing a problem they would like to address and avoid. After the relevant stages are ascertained, the process flow moves on to decision step 314.

In step 314, it is determined whether additional stages of the pre-defined process need to be elaborated. If so, the generate new prediction models block 18 proceeds to step 316. If not, then the generate new prediction models block 18 ends execution.

In step 316, process instance data, read from the warehouse 412 in step 310, is prepared for the data mining techniques to subsequently applied.

In step 318, the data mining techniques are applied to the process instance data.

In step 320, the results from step 318 are assembled into analysis and predictions tables, and are thereafter stored in warehouse 412. The analysis and predictions tables stored in warehouse 412 are accessible by system users and by monitoring components of the system to be subsequently described. The process steps 316, 318 and 320 are performed in an execution loop, until the relevant stages to be elaborated are exhausted, as determined by step 314. Upon exhaustion, block 18 is ended in step 322.

As an example, one of the data mining techniques that can be used is Classification. Classification techniques take as input a set of objects and a set of classes to which the objects belong (each data item belongs to one and only one class), and derive (extract) the rules that according to which a data item belongs to a class. Rules are often expressed in terms of the properties of the object. By providing this rules to the analysts, the present invention helps the analysts in understanding why objects (business process executions) belong to certain classes (i.e., have certain characteristics of interest to the analyst).

FIG. 6 illustrates the monitoring process 20. In step 22, the analysis and predictions tables generated in step 320 are read.

In step 24, management policies are utilized in the evaluation of the analysis and prediction tables so as to notify users and system components of critical process parameter values which have been identified or predicted. For example, the data analysis and prediction process 10 may have resulted in a prediction that a certain deadline (e.g., a deadline specified in a service level agreement) is likely to be missed at some point in the near future. A management policy could for example state that when the deadline is likely to be missed with more than 90% probability, an email should be sent to the system administrator. In step 24, the pertinent system elements and system users would be notified so that corrective action may be taken to avoid missing the deadline and to fulfill the service level agreement.

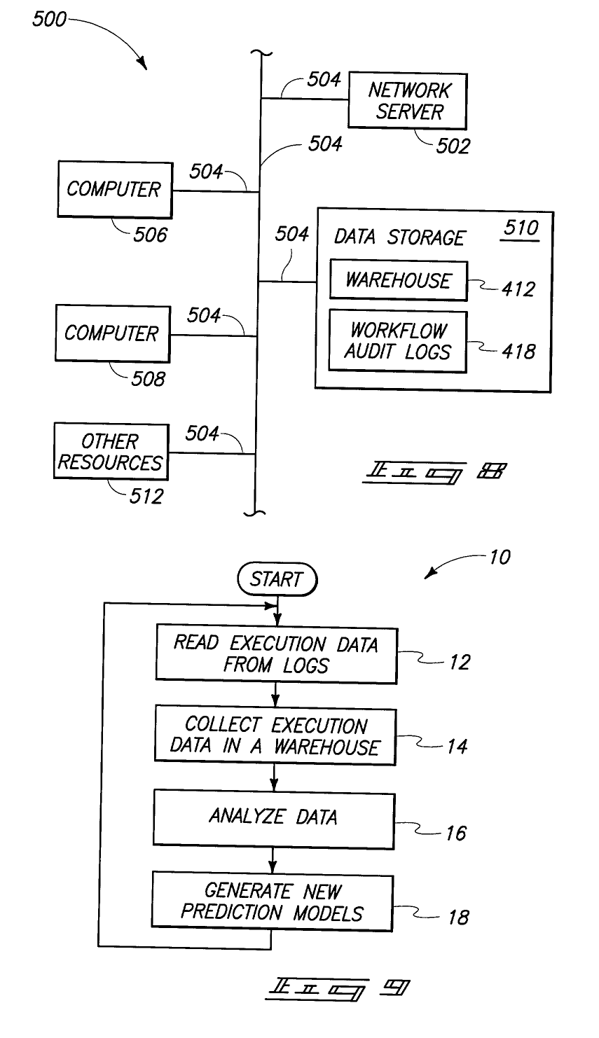

FIG. 8 provides a hardware diagram illustrating computing resources typically used to define a workflow management system 500. The system 500 includes, for example, a network server 502; a network 504; computer workstations 506 and 508; data storage 510; and other resources 512. The server 502, workstations 506, 508, the storage 510 and the resources 512 are coupled together by a network 504, defined by cable, network cards, and appropriate network software. The data storage 510 typically includes an array of magnetic disk storage drives; however other data storage may be used such as solid-state memory; tape storage; optical disk storage; etc. Data Storage 510 contains warehouse 412 and Workflow audit logs 418.

The network server 502 provides necessary routing and data handling for communications on the network 504. Workstations 506 and 508 provide user access to data in the storage 510, such as, for example, business process execution data stored in the logs 418 and the analysis and prediction tables stored in warehouse 412. Workstations 506 and 508 also run integrated business intelligence software serving as the ‘front end’ or access format seen by the user. Such a front end permits intelligent searches of the analysis and predictions tables stored in the warehouse 412, while further permitting the use of intelligent tools to alter the system algorithms and definitions used in generating the tables (as previously described).

FIG. 9 is a flowchart of a data analysis system 10 having the same aspects as illustrated in FIG. 1, including an iterative execution loop. The system 10 of FIG. 8 is repeatedly executed such that prediction models are being continuously updated responsive to changes in business process execution data.

The protection sought is not to be limited to the disclosed embodiments, which are given by way of example only, but instead is to be limited only by the scope of the appended claims.

What is claimed is:

1. A method of analyzing data and making predictions, comprising:
reading process execution data from logs;
collecting the process execution data and storing the process execution data in a memory defining a warehouse;
analyzing the process execution data; and
generating prediction models in response to the analyzing.

2. A method of analyzing data and making predictions in accordance with claim 1 wherein the reading comprises determining correlation among entries in the logs of different systems, in order to label data entries that are related to the same business process, checking the execution data for inconsistencies, and removing inconsistent data.

3. A method of analyzing data and making predictions in accordance with claim 1 wherein the collecting comprises computing statistics relating to the execution data, and performing data mining on the execution data.

4. A method of analyzing data and making predictions in accordance with claim 1 wherein the generating prediction models comp rises determining critical parameters within a process from which the execution data was generated.

5. A computer-based system comprising:
a memory defining execution logs configured to store business process execution data;
a memory defining a warehouse configured to store a plurality of types of data, a prediction model, and a process definition;
a memory bearing computer software code that, when loaded in a general purpose computer, selectively extracts business process execution data from the log and stores the extracted business process execution data in the warehouse;
a memory bearing computer software code that, when loaded in a general purpose computer, defines a business process intelligence engine configured to execute an algorithm responsive to at least some of the types of data stored in the warehouse and to store result data in the warehouse; and
a memory bearing computer software code that, when loaded in a general purpose computer, defines a monitoring and optimization manager configured to predict an occurrence of an exception in a business process execution responsive to at least some of each of the data stored in the warehouse, the business process execution data, and the process definition.

6. A system in accordance with claim 5, and further comprising a resource configured to complete the business process execution responsive to the process definition.

7. A system in accordance with claim 6 wherein the resource comprises a computer-based function.

8. A system in accordance with claim 5 wherein the exception is a user-definable exception.

9. A system in accordance with claim 5 wherein the monitoring and optimization manager is further configured to selectively perform at least one action responsive to the prediction.

10. A system in accordance with claim 5 and further comprising a plurality of process definitions and at least one resource configured to complete at least a portion of a business process execution responsive to the corresponding process definition.

11. A system in accordance with claim 10, wherein the at least one resource is defined by a computer.

12. A system in accordance with claim 10, wherein the at least one resource comprises a computer-based function.

13. A method comprising:
storing a plurality of business process execution data in a database;
selectively extracting at least some business process execution data from the database;
applying a first algorithm to the extracted data and storing at least one data table in the database responsive to the first algorithm; and
applying a second algorithm to the at least one data table and selectively predicting an exception to a business process execution responsive to the second algorithm.

14. A method in accordance with claim 13, wherein the exception is pre-defined by a user.

15. A method in accordance with claim 13, and further comprising performing an action responsive to the predicting.

16. A method in accordance with claim 15, wherein the action is performed by an automated resource.
